(19) United States
(12) Patent Application Publication
(10) Pub. No.: US 2025/0111721 A1
(43) Pub. Date: Apr. 3, 2025

(54) Wireless Access Systems and Methods

(71) Applicant: Christopher Babcock, Nashville, TN (US)

(72) Inventor: Christopher Babcock, Nashville, TN (US)

(21) Appl. No.: 18/375,532

(22) Filed: Oct. 1, 2023

(51) Int. Cl. G07C 9/20; H04W 4/021; H04W 84/12

(52) U.S. Cl. CPC G07C 9/20; H04W 4/021; H04W 84/12

(57) ABSTRACT

A Low Power Wide Area Network (LPWAN) perimeter access system. A plurality of low power wide area network wireless (LPWAN) entry devices and one or more LPWAN gateways may communicate over a wireless network. One or more radio links enables the plurality of LPWAN entry devices to be in radio communication with the one or more LPWAN gateways. At least one network server may connect to the one or more LPWAN gateways via a standard IP connection. The one or more LPWAN gateways act as a transparent bridge, converting RF packets to IP packets.

### FIELD

The present disclosure relates generally to wireless electronic devices and systems. More particularly, the present disclosure generally relates to wireless electronic devices and systems for securely and wirelessly associating security devices with one or more access control systems.

### BACKGROUND

Robust and secure access in homes, hotels, rental cars, and other similar secure environments has been problematic. One reason it has been problematic is because of the need for keys that may be used by multiple different individuals over multiple time periods. As just one example, mechanical locks that required traditional metallic keys provided an initial solution. However, these traditional metallic keys needed to be physically stored, cataloged, and passed on from guest to guest over an extended period of time.

As such, these types of mechanical keys were often stolen, lost, misplaced, and/or damaged. Moreover, with lost or misplaced keys, these corresponding mechanical locks were often required to be rekeyed. Such rekeying efforts were often a costly and a time-consuming endeavor which oftentimes would require on-site service by a trained technician.

More recently, electronically controlled locks have been used. For example, some of these electronically controlled locks would require a magnetic card reader. However, these electronically controlled locks also posed certain challenges as each time the secured room or space is given to a new guest or a new renter, the code necessary to enter the space must be changed. Therefore, typically a new key card must be issued with the code magnetically encoded on the magnetic stripe.

There is therefore a general need for perimeter control systems and methods that utilize certain advantages of an electronic, wireless based system. Certain of these advantages include, but are not limited to, the advantages of the wireless transmission range of radio signals, remote access, reduced data rates and bandwidth, and a reduced cost of components.

### SUMMARY

According to an exemplary arrangement, a perimeter access system comprising a plurality of entry devices; at least one gateway; at least one radio link enabling the plurality of entry devices to be in radio communication with the at least one gateway; and at least one network server operatively coupled to the at least one gateway by way of an IP connection, wherein the one or more gateways act as a transparent bridge.

In another arrangement, an entry device may communicate with a plurality of other entry devices in a mesh configured network topology. In one arrangement, an entry device or operating mesh node may do this either to request and receive its configuration held in another entry device's storage, potentially some or all entry devices have some or all the other devices configuration, or use another entry device to communicate with a server directly, or a gateway for an updated or revised system configuration, like a relay. In one arrangement, one entry device or mesh node may reach out to another entry device or mesh node, that then reaches out to yet another and so on while attempting to receive an updated configuration.

In one arrangement, the perimeter access system comprises a Low Power Wide Area Network (LPWAN) perimeter access system. In one arrangement, the LPWAN perimeter access system utilizes an LPWAN standard protocol.

In one arrangement, the perimeter access system grants access to a secured perimeter. In one arrangement, the secured perimeter comprises an enclosed outdoor space. In one arrangement, the enclosed outdoor space comprises a hotel room.

In one arrangement, the entry device is provided on a moveable barrier. In one arrangement, the moveable barrier comprises a hotel room door.

In one arrangement, the gateway converts converting Radio Frequency (RF) packets to IP packets.

In one arrangement, the perimeter access system is configured as a LoRaWAN network architecture deployed in a star-of-stars topology.

In one arrangement, the network server comprises a cloud-based platform solution.

In one arrangement, a method of providing remote access to an entry device, comprising the steps of accessing a perimeter access system by an authorized user; requesting an entry device configuration by the authorized user; validating the request; authorizing the request; and applying the requested entry device configuration to the entry device.

In one arrangement, the authorized user comprises a hotel administrator.

In one arrangement, the entry device comprises a moveable barrier.

In one arrangement, the moveable barrier comprises a hotel room door.

In one arrangement, the method further comprises the step of accessing the perimeter access system utilizing a mobile computing device. For example, in one arrangement, the mobile computing device comprises a smartphone.

In one arrangement, the method further comprises the step of sending a message to an authorized user indicating a status of the request.

In one arrangement, the method further comprising the step of monitoring a status of the entry device.

In one arrangement, the method further comprising the step of reconfiguring the entry device.

In one arrangement, different cryptographic schemes and implementations may be used across the system for communication, verification, and/or authority.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a high-level diagram of a Lower Power Wide Area Network (LPWAN) perimeter access system, according to an example arrangement;

FIG. 2 illustrates a logic flow diagram a Lower Power Wide Area Network (LPWAN) perimeter access system, according to an example arrangement;

FIG. 3 illustrates an exemplary view of a Lower Power Wide Area Network (LPWAN) perimeter access system, according to an example arrangement;

FIG. 4 illustrates an exemplary view of a mesh perimeter access system, according to an example arrangement; and

FIG. 5 illustrates an exemplary view of a mesh perimeter access system, according to an example arrangement.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

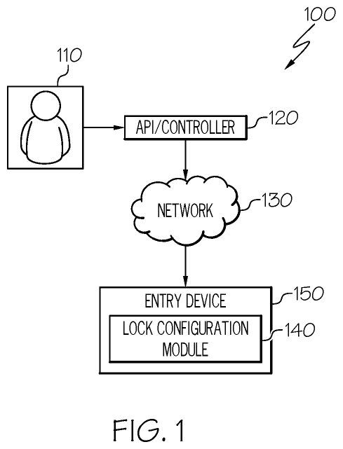

FIG. 1 illustrates an exemplary high-level diagram of a Lower Power Wide Area Network (“LPWAN”) perimeter access system 100, according to an example embodiment. LPWAN perimeter access system 100 may be utilized to grant or deny access to a secured perimeter, including but not limited to a hotel room, a home, an apartment unit, a storage unit, a cruise ship cabin door, or a gated field or other enclosed outdoor space.

Access to this secured perimeter may be granted or denied by controlling or changing the configuration of an entry device that is associated with the secure perimeter. For example, such an entry device may be provided on a hotel room door or other similar moveable barrier (i.e., a gate) for a home, a garage door, a rental vehicle, a cabin door of a cruise ship, a storage unit, or other similar secured area.

As illustrated in FIG. 1, system 100 first utilizes an authorized user 110 that has access to system 100 and utilizes this access to initiate a change to an entry device already existing in the overall network. Authorized user 110 may be a front desk clerk in a physical hotel lobby, or may be a mobile device application operated by a hotel guest which enables remote check-in. In one or more embodiments, where the LPWAN is utilized in a hotel having a network of hotel structures, authorized user 110 may be a front desk reception clerk of a hotel that accesses the system.

When a new guest arrives at the hotel, the reception clerk may be required to make a particular change to a particular lock for a particular hotel room in a particular hotel to allow the new guest hotel room access. By utilizing such a LPWAN system, the hotel room of the particular hotel may be located remotely from where the reception clerk is geographically positioned. In cases where authorized user 110 is operating a mobile device app, authorized user 110 may be in any location providing internet access.

In an embodiment, authorized user could initialize a change to the entry device configuration by utilizing a mobile device, including but not limited to a smartphone, tablet, laptop, or other similar graphical user interface device, to access API/Controller 120. API/Controller 120 may provide the authorized user access to the system over network 130. In one preferred arrangement, the network 130 may comprise a LoRa Wize, Dash7, Wifi, Cellular, and/or a wired system. However, those of ordinary skill in the art will recognize, alternative network systems may also be utilized.

Having gained access to the system, authorized user 110 may then initialize the lock or change a lock setting via Lock Configuration Module 140 which enables the hotel guest access to the particular secured area associated with Entry Device 150. In this disclosure, the term “lock configuration” may refer to any operation to control access to a particular lock, including but not limited to unlocking the lock, locking the lock, or assigning a unique identifier to a lock to enable access via a key card, QR code, PIN or mobile device.

Access to the secured area may then be gained by hotel guest by way of a number of authorized methods. As just one example, such authorized methods may include but not limited to utilizing a QR code, a PIN/Password combination, a biometric characteristic, and/or a magnetic card. In other embodiments, the authorized method may be enabled on a user's personal computing device, like a smartphone or mobile device, including but not limited to Bluetooth and Near Field Communication (NFC).

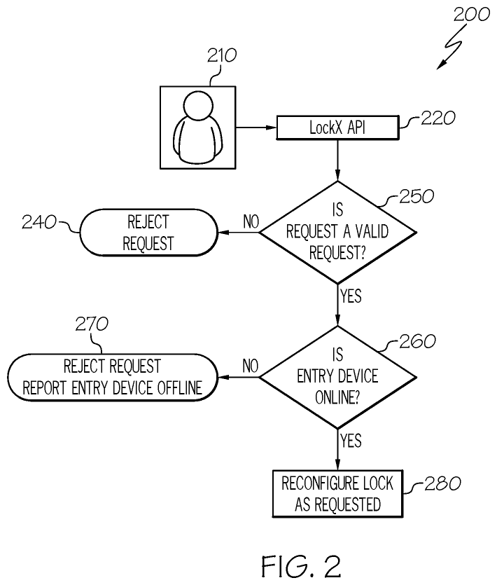

FIG. 2 illustrates a logic flow diagram of one embodiment of a perimeter access system, such as an LPWAN perimeter access system 200. As illustrated in this logic flow diagram, in order to access the system in one preferred arrangement, the authorized user 210 accesses an API 220. After gaining proper access to this API, the authorized user can then generate a request on the system. As just one example, such an administrator may be an employee or contractor of the perimeter access system, such as the front desk clerk of a hotel. As just one example, the front desk clerk may access the API through a computer terminal or mobile device so as to configure the lock to the room for the hotel guest that is presently seeking a room assignment.

Once the administrator logs onto the system, this API provisions the entry device ahead of time, before the hotel guest is at the door. In such a proactive system, at step 250, the system will ascertain if the administrator's request is a valid request. In one embodiment, such a proactive system may check or verify or confirm that a requested room is properly cleaned and ready for guests prior to validating the request. In one embodiment, such a proactive system may only validate requests from certain hotel staff at certain times. Alternatively, or in addition, the system may optionally check for a new configuration. If the request is valid, the system will proceed to step 260.

Alternatively, if the system determines that the request is not a valid request, then the system will proceed to step 240. Then, at step 240 is where the authorized user's request is rejected. At step 240, a message may optionally be sent to authorized user 210 indicating the rejection of the request.

At step 260, the system will inquire whether the particular entry device that the authorized user is presently configuring is on-line, powered up and properly residing on the LPWAN. If the lock is not on-line, the system will proceed to step 270 where the system will advise the administrator that the lock is off-line and that a potential lock configuration change or update is not allowable. As such, access to the lock's configurations will be rejected. In operation, authorized user 210 may select another lock and re-attempt the configuration request.

Alternatively, if the lock is not off-line, the system will proceed to step 280 and allow the administrator to reconfigure the lock as requested. If access to the lock is allowed, the configuration will be updated and a logic block of the system will allow the guest to access to the locked perimeter by way of the now configured entry device. In one embodiment, the system may inquire the API/controller for a new lock configuration.

In addition, following any access attempt or access event that has occurred, the system may send a notification back to the server providing notice to interested parties, including but not limited to the front desk staff, the accounting department, the housekeeping staff or the security office. Alternatively, at a subsequent logic block, the system may seek a revised or updated configuration request.

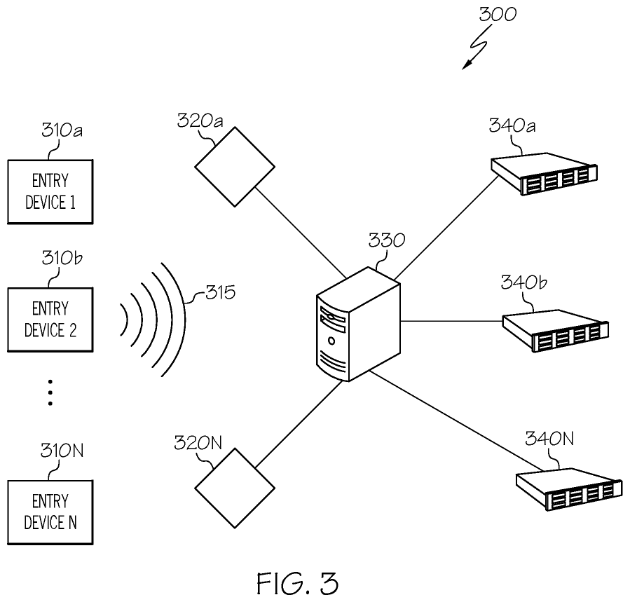

FIG. 3 illustrates one embodiment of an LPWAN perimeter access network architecture 300 that may be utilized with the systems and methods disclosed herein. In this illustrated arrangement, the architecture 300 comprises an LPWAN perimeter access network architecture 300 that may be utilized with the systems and methods disclosed herein. In the embodiment shown in FIG. 3, the system network architecture 300 comprises a plurality of entry devices. FIG. 3 shows three entry devices, 310a, 310b and 310N, but any number of entry devices may practice the disclosed invention. Entry devices 310a, 310b and 310N are connected such that each entry device interacts with at least one LPWAN gateway or concentrator 320a or 320N over wireless network 315. FIG. 3 shows two gateway devices, 320a and 320N, but any number of gateway devices may practice the disclosed invention.

In one embodiment, the exemplary LPWAN system may use different types of standard protocols over wireless connection 315. As just one example, in one embodiment, the exemplary LPWAN system may use different types of LPWAN standard protocols over wireless connection 315. These standard protocols may include but are not limited to IEEE (802.154k, 802.15.4g, 802.11), Long Range Low Power (LRLP), ETSI (Low Throughput Networks (LTN)), 3GPP (enhanced MTC (eMTC), Extended Coverage GSM (EC-GSM), NarrowBand IoT (NB-IoT)), IETF (6LPWA/LP-WAN)), Weightless SIG (Weightless-W/NP), LoRa Alliance (LoRaWAN) and/or DASH7 Alliance (Dash7).

The LPWAN systems and methods disclosed herein offer a number of advantages over other conventional systems. As just one example, the disclosed systems and methods generate long range capabilities of approximately 5 to 40 Km in open field regions. In one embodiment, the check-in location for a hotel or other secure establishment may reside up to 40 Km away from where the hotel room and corresponding door lock may be located. In another embodiment, livestock access to different fields may be controlled remotely from a central location by enabling the opening and closing of gates or other access control devices without requiring lengthy and dangerous travel to the location of access gates. In addition, with an LPWAN based system, since the entry devices are configured to consume very low power, the power source contained within the various door locks may not need to be replaced or serviced over an extended period of time.

For large hotel chains having multiple hotel locations, having multiple hotel rooms, such energy efficient devices can provide a significant economic advantage by way of labor and cost savings. In addition, since such systems and methods only require throughput of a few hundred bits/second or less, cost effective radio chipsets may also be utilized. In addition, LPWAN systems and methods offer very good geographical coverage with good in-building penetration where multiple locks will need to be installed on multiple doors that are interior to a building structure.

In one embodiment, the system network LPWAN architecture may comprise a LoRaWAN network architecture and be deployed in a star-of-stars topology. The LoRaWAN networks laid out in a star-of-stars topology may comprise one or more gateways or concentrators 320a and 320N. The one or more gateways or concentrators may be used for relaying data between the one or more entry devices 310a, 310b and 310N, and a network server 330. Communication between the one or more entry devices and the gateways or concentrators may be communicated over the wireless channel 315 utilizing the LoRa physical layer, while the connection between the gateways and the network server 330 may be handled over a backbone IP-based network.

The system may include one or more LPWAN end node entry devices (310a, 310b, 310N), including but not limited to door locks, motorized garage doors or motorized gates, and one or more gateways (320a, 320N). In one embodiment, the end nodes transmit over wireless network 315 directly to all gateways within a certain range. Transmission over network 315 may be using LoRa or another wireless transmission protocol. In one embodiment, the gateways relay messages between end-devices and network server 330 using an IP-based network.

In one embodiment, the end node entry devices may include a LoRa embedded transponder that is used to transmit signals over LoRa radio transmission method. In addition, the entry devices may optionally comprise a micro-controller (with or without on-board memory). The entry devices may connect to the LoRa transponder device, or the entry devices may be an integrated unit with the LoRa embedded transponder device.

In one embodiment, the LoRa end nodes may utilize low power, may be battery powered (Class A and Class B), and may transmit signals over distances up to 40 km.

As also illustrated in FIG. 3, the LoRa based entry devices may transmit data to the LoRa gateways. As illustrated, two gateways are shown (320a and 320N), but those of ordinary skill in the art will recognize alternative gateway arrangements may also be utilized. The gateways are deployed along a coverage area and allow for the exchange of information with the entry devices via a specific radio link. The gateway may not perform any data processing. Rather, the gateways may perform the gateway function to an IP network that links them to the network. The LoRa gateways may connect via the standard IP protocol and transmit the data received from the LoRa embedded sensors to a network or cloud-based server 330. The gateway devices may be connected to a power source. The gateways may connect to network server 330 via standard IP connections and act as a transparent bridge, converting RF packets to IP packets and vice versa.

Network server 330 may be a cloud-based platform solution, including but not limited to The Things Network (TTN), LoRIOT, or private connections. The network servers may connect to the gateways and route its received information to the relevant application servers (340a, 340b, 340N). FIG. 3 shows three application servers, but those skilled in the art will understand that any number of application servers may be included in the network architecture. The network servers may be used for both uplink or downlink communication.

The network server 330 may perform the function of device management. That is, the network server may register, authenticate and/or manage data traffic over the network. Depending on the quality of the link, the network server may ask the entry devices for readjustments in the speed of transmission and of bandwidth. Regarding the received frames, the network server verifies the received frames for integrity and discards duplicates. The network server also may be responsible for the management of the one or more gateways, maintaining a database with those entry devices registered in the network and selecting the most appropriate entry device to transmit the download information according the received signal level.

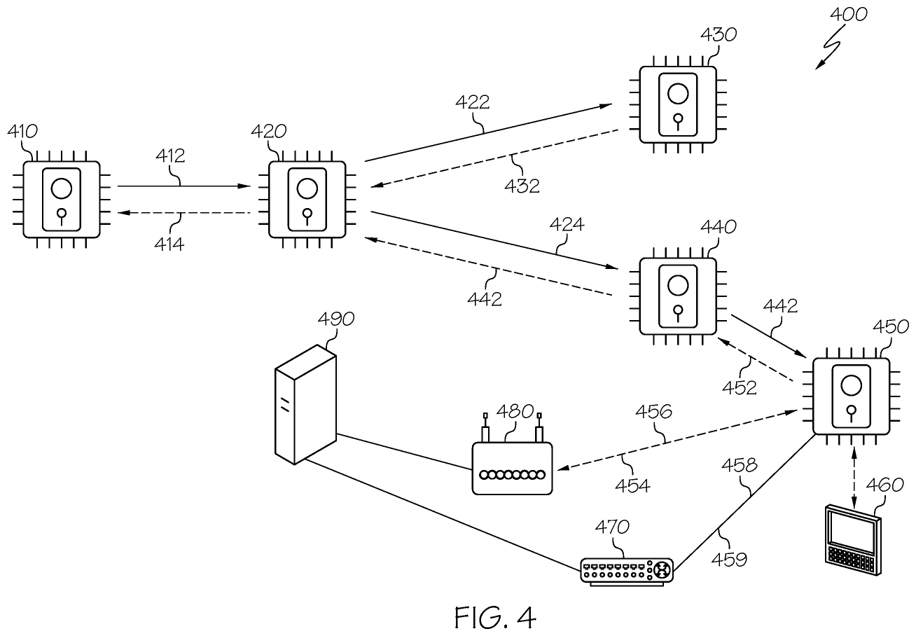

FIG. 4 illustrates one embodiment of an LPWAN perimeter access network architecture 400 that may be utilized with the systems and methods disclosed herein. In this illustrated arrangement, the architecture 400 comprises an LPWAN perimeter access network architecture 300 that may be utilized with the systems and methods disclosed herein. In the embodiment shown in FIG. 4, the system network architecture 300 comprises architecture in which a lock configuration can be acquired directly or indirectly from another configuration device, from a server, or from a portable configuration device. This lock configuration can then be communicated amongst the various entry devices making up the perimeter network architecture 400.

In one preferred arrangement, the network architecture 400 comprises a mesh network architecture. A mesh communications architecture is a type of network design where each node or each entry device in the network can communicate directly with every other node or entry device in the network, thereby forming a mesh-like communications network or communications structure. In this architecture, data is transmitted through multiple paths to reach its destination, allowing for greater redundancy and reliability.

In a mesh network, such as the mesh network 500 illustrated in FIG. 4, each node or entry device acts as both a transmitter and a receiver and can forward data to other nodes in the network 500. This creates multiple routes for data transmission, which helps to ensure that data can be transmitted even if one or more nodes fail or become unavailable.

Mesh networks, like the mesh network illustrated in FIG. 4, can be deployed in many different types of environments, from small, local networks to large-scale, global networks. They can be used for a variety of applications, including secured areas and locations, wireless sensor networks, industrial control systems, and military communication networks.

One of the key advantages of mesh networks is their ability to self-heal. That is, if a node in the network fails or becomes unavailable, the other nodes can automatically reroute data through other paths to reach the desired destination. This makes mesh networks particularly useful in environments where nodes are constantly changing or where network disruptions are common.

Another advantage of mesh networks is their scalability. Because nodes can be added or removed from the network without affecting the overall architecture, mesh networks can grow or shrink to meet changing needs.

Mesh networks can be implemented using a variety of different communication technologies, including wireless mesh networks, wired mesh networks, and hybrid mesh networks.

In a wireless mesh network (WMN), nodes communicate with each other wirelessly using Wi-Fi, Bluetooth, or other wireless protocols. Nodes are equipped with radio transceivers that allow them to transmit and receive data wirelessly. Wireless mesh networks can be deployed quickly and inexpensively, making them an attractive option for building ad-hoc networks in areas where wired infrastructure is unavailable. However, wireless mesh networks can suffer from interference and other forms of signal degradation that can affect network performance.

In a wired mesh network, nodes are connected to each other using wired connections, such as Ethernet cables. Wired mesh networks offer high reliability and performance, as wired connections are less susceptible to interference and signal degradation than wireless connections. However, wired mesh networks can be expensive to install and maintain, and are not suitable for areas where wired infrastructure is unavailable.

A hybrid mesh network is a combination of wired and wireless mesh networks. In a hybrid mesh network, nodes are connected to each other using both wired and wireless connections. This allows for greater flexibility and scalability, as nodes can be connected to the network using the most appropriate method for their location and environment. Hybrid mesh networks are often used in large-scale deployments, such as smart cities or industrial IoT applications.

In addition to these communication technologies, mesh networks can also be implemented using different routing protocols. These protocols determine how data is transmitted between nodes in the network. Examples of routing protocols used in mesh networks include Ad-Hoc On-Demand Distance Vector (AODV), Dynamic Source Routing (DSR), and Optimized Link State Routing (OLSR). These routing protocols enable mesh networks to be highly resilient and self-healing, as they allow nodes to dynamically adapt to changes in the network topology.

Overall, mesh communications architecture is a powerful and flexible approach to network design that offers many advantages over traditional network architectures. By enabling multiple paths for data transmission and self-healing capabilities, mesh networks provide a robust and reliable way to transmit data in a wide range of environments.

As illustrated, this mesh system network 400 comprises a plurality of mesh nodes or entry devices 410, 420, 430, 440, and 450, a configuration server 490, a LPWAN Gateway 480, a wired network switch/router 470 and a portable configuration device 460. In this illustrated arrangement, the initial requester comprises a first entry device 410 (i.e., Lock 1) initiates a request 412 seeking configuration data for the first entry device 410. Where the system network comprises a mesh system network, the first entry device 410 can submit a request for this configuration data to any entry device within the perimeter access network architecture 400.

Another way to describe this access network architecture is in terms of reactive versus proactive network architectures. As an example, a reactive architecture is one where one or more locks wait for an access request. This is I contrast to a proactive architecture where one or more locks proactively share a configuration before an access request. In one preferred arrangement, in both scenarios the entire network could be configured out of band (i.e., air gapped), that is without a gateway, or using an existing network.

In one preferred arrangement, communications between or amongst the one or more locks could include errors, diagnostic data, locks in network, locks up to data, location data and/or other like or similar data.

However, in the present illustrative arrangement, the first entry device 410 submits this request 412 to another entry device and as seen in this illustration this request 412 would be submitted to a second entry device 420 (i.e., Lock 2) by way of a request 412. The submitted request 412 can identify various forms of information. As just one example, the request 412 identifies the initial requester as the first entry device 410 and requests or asks the second entry device 420 whether it has configuration information for the first entry device 410.

In response, the second entry device 420 submits a request 422 to another entry device within this network. Specifically, within this illustrated arrangement, this request 422 is submitted to a third entry device 430 (i.e., Lock 3). The submitted request 422 identifies the initial requester as the second entry device 420 and requests or asks the third entry device 430 if the third entry device 430 has configuration information for the first entry device 410.

The second entry device 420 may include additional information in this communicative request 422. As just one example, the second entry device 420 may provide further search information within this request 422. For example, the second entry device 420 may inform the third entry device 430 that the second entry device 420 has already requested other entry devices operating within this network as to their availability of configuration information for the first entry device. As just one example, the second entry device 420 may inform the third entry device 430 that the second entry device 420 has already asked the fourth entry device 440 for this configuration information.

Assuming that the third entry device 430 does not have this configuration data for the first entry device 410, the third entry device 430 will reply back to this request 422 by informing the second entry device 420 that that this is the third entry device 430 and that it does not have the configuration data for the first entry device 410. In addition, the third entry device 430 may include additional information in this reply 432 by including information that the third entry device 430 has not made any other further inquiries of the various other nodes or entry devices operating within the network system 400.

Now, once this information is received back from the third entry device 430 by way of reply 432, the second entry device 420 reaches out to yet another entry device operating within the network 400. In this particular illustrative arrangement, the second network device 420 sends out another request 424 to a fourth entry device 440 (i.e., Lock 4) operating in the network 400. Again, the request 424 identifies the initial requester as the second entry device 420 and requests or asks the fourth entry device 440 if the fourth entry device 440 has configuration information for the first entry device 410.

In response to this request 424 from the second entry device 420, the fourth entry device 440 transmits a request to a fifth entry device 450 (i.e., Lock 5). Specifically, the fourth entry device 440 transmits a request 442 including an identifier identifying itself as the fourth entry device 440 operating within the network 400 and that it is inquiring as to whether this fifth entry device 450 has configuration data for the first entry device 410 operating within the network 400.

In response to this request 442 from the fourth entry device 440, the fifth entry device 450 transmits a reply 452 to the fourth entry device 440 (i.e., Lock 4). Specifically, the fifth entry device 450 transmits a reply 452 that comprises an identifier identifying itself as the fifth entry device 450 operating within the network 400 and that it does indeed have configuration data for the first entry device 410 operating within the network 400. Aside from identifying itself as the fifth entry device 450 and that it had this configuration data for the first entry device 410, the fifth entry device 450 may also provide additional data back to the requesting entry device, the fourth entry device 440 in this particular communication illustration.

As just one example, the fifth entry device 450 may also provide additional data related to where it had obtained this configuration data for the first entry device 410. As just one example, the fifth entry device 450 may have obtained this configuration data from a configuration server 490 by, for example, submitting an inquiry to this configuration server via a gateway, such as an LPWAN gateway 480. In this particular arrangement, the fifth entry device 450 would have requested this information by way of a request 454 transmitted over a radio link or radio path 456.

Alternatively, the fifth entry device 450 may have obtained this configuration data from transmitting a request 458 by way of a hard-wired connection 459 to a switch/router 470 who then received this information from the configuration server 490. Alternatively, the fifth entry device 450 may have obtained this configuration data from a portable configuration device 460 such as a custom tablet of a hand-held computing device, like a smartphone. As those of ordinary skill in the art will recognize, the request and reply communications illustrated in FIG. 4 are merely illustrative and different communications may take place.

Now that it has the configuration data for the first entry device 410, the fifth entry device 450 needs to communicate this information back to the fourth entry device 440, the entry device that had originally requested this information by way of request 442. To achieve this transmission, the fifth entry device 450 transmits a reply 452 in response to the original request 442 from the fourth entry device 440 informing the fourth entry device 440 that this reply 452 is being sent by the fifth entry device 450. This reply 452 also confirms that the fifth entry device 450 does have the configuration data for the first entry device 410. In addition, the fifth entry device 450 may provide further information to the fourth entry device 440 as to how the fifth entry device 450 obtained this configuration information.

Having now received this confirmation information that the fifth entry device 450 did indeed have the configuration data for the first entry device 410, the fourth entry device 440 transmits a reply 442 back to the second entry device 420. This reply will again identify the fourth entry device 440 as the transmitting entry device transmitting reply 442 and will also inform this second entry device 420 that the fourth entry device 440 received the configuration data for the first entry device 410 from the fifth entry device 450. In one arrangement, the fourth entry device 440 may also describe how and when the fifth entry device 450 obtained this configuration data (e.g., from the configuration server 490 (via radio path 456 or wired connection 459) or via portable configuration device 460).

And now finally, having received this confirmation information that the fourth entry device 440 did indeed have the configuration data for the first entry device 410, the second entry device 420 transmits a reply 414 back to the first entry device 410. This reply 414 will identify the transmitting entry device of this reply 414 as the second entry device 420 within the network 400. In one preferred arrangement, the reply 414 will also inform this first entry device 410 that the second entry device 420 received the configuration data for the fifth entry device 450 via the fourth entry device 440. In one arrangement, the second entry device 420 may also utilize the reply 414 to describe where the fifth entry device 450 obtained this configuration data (e.g., from the configuration server 490 (via radio path 456 or wired connection 459) or via portable configuration device 460).

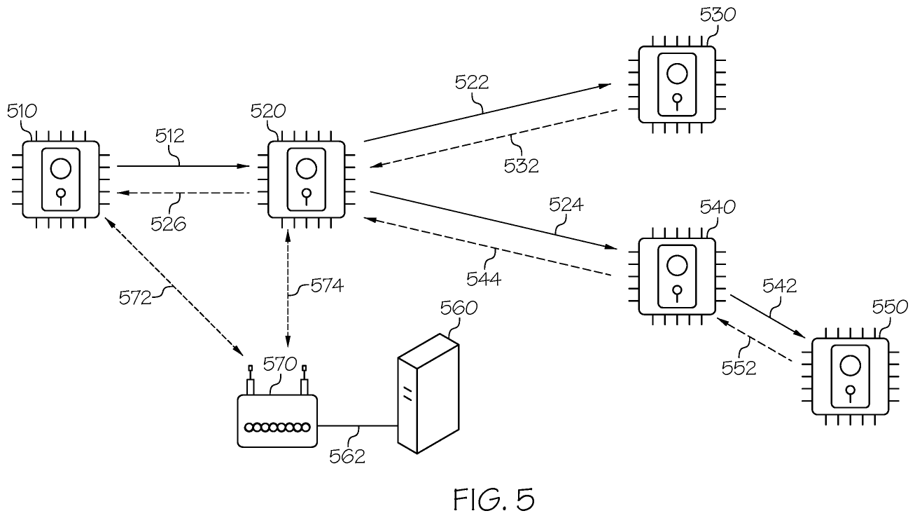

FIG. 5 illustrates one embodiment of an LPWAN perimeter access network architecture 500 that may be utilized with the systems and methods disclosed herein. In this illustrated arrangement, the architecture 500 comprises an LPWAN perimeter access network architecture 300 that may be utilized with the systems and methods disclosed herein. In the embodiment shown in FIG. 5, the system network architecture 500 comprises an architecture in which a lock configuration or configuration data can be acquired directly or indirectly from another configuration device, from a server, or from a portable configuration device. In one preferred arrangement, the network architecture 500 comprises a mesh network architecture comprising a plurality of entry devices or mesh nodes.

In this configuration, an updated configuration to the entry devices may occur via some kind of network or via a portable configuration device, like the portable configuration device illustrated in FIG. 4. This incidentally creates a shared state via stateless ad hoc communications. In this illustrated example, an update is sent via an LPWAN gateway to those entry devices that are operationally coupled to the LPWAN gateway 570. In this preferred arrangement, only the first entry device or first node 510 (i.e., Lock 1) and the second entry device or second node 520 (i.e., Lock 2) have a radio path to the gateway. As just one example, the first entry device or first node 510 (i.e., Lock 1) has radio path 572 to the LPWAN gateway 570. Similarly, the second entry device or second node 520 (i.e., Lock 2) has a radio path 574 to the LPWAN gateway 570. However, as those of ordinary skill in the art will recognize, alternative communication channels and radio path configurations may be utilized as well.

The entry devices or mesh nodes offer the configuration to all other devices and based on a time stamp, configuration sequence and or other factors it decides whether it will take the updated configuration. This configuration update contains all of the configuration information or configuration data for all entry devices in the node or network architecture 500. The locks may or may not update the server of its configuration version status.

Returning to FIG. 5, as illustrated, this network 500 comprises a first entry device 510, a second entry device 520, a third entry device 530, a fourth entry device 540, and a fifth entry device 550, an LPWAN Gateway 570, and configuration server 560. As illustrated, only a plurality of these entry devices are in communication with the LPWAN Gateway. For example, in this illustrated arrangement, only the first entry device 510 (i.e., Lock 1) and the second entry device 520 (i.e., Lock 2) are in communication with this LPWAN Gateway. Therefore, in this illustrated arrangement, it is only these two entry devices or mesh nodes 510 and 520 that are operably capable of receiving configuration data directly from the configuration server 560 by way of the LPWAN gateway 570. However, as those of ordinary sill in the art will recognize, alternative entry device connection and configuration server arrangements can be utilized as well.

In this illustrated arrangement, the initial requester comprises a first entry device or a first mesh node (i.e., Lock 1) and as illustrated comprises a first radio path 572 with the gateway 570. As such, the first entry device 510 receives updated configuration data or configuration information directly from the gateway 570 which is communicatively coupled by way of the data link 562 to the configuration server 560.

As illustrated, the first entry device 510 initiates a request 512 seeking an initial request for the most up to date configuration (i.e., configuration sequence 10) for any device within the network. The first entry device 510 submits this request to another entry device within the network 500, as illustrated, this first mesh node issues this request to a second entry device 520 (i.e., Lock 2). The submitted request identifies the initial requesting entry device 510 as the first entry device and requests or asks the second entry device 520 if it has the most up to date configuration information via request 512.

In response, the second entry device 520 submits an inquiry or a request 522 to another entry device within the network 500. As just one example, in this illustrated arrangement, this request 522 is initiated by the second entry device 520 and is submitted to a third entry device 530 (i.e., Lock 3). The submitted inquiry or submitted request identifies the requester as the second entry device 520 and requests or asks the third entry device 530 if the third entry device 530 has the updated configuration information for entry devices operating within the network 500. In addition, the second entry device 520 may also include (within the request 522) additional information. As just one example, the second entry device 520 may provide further search information within this request 522. For example, the second entry device 520 may inform the third entry device 530 that the second entry device 520 has already requested other entry devices operating within this network as to whether these other entry devices have the updated configuration information.

Assuming that the third entry device does not have this updated or current configuration data or configuration information, the third entry device 530 will issue a reply 532 back to the second entry device 520 informing the second entry device 520 that this is the third entry device 530 and that this third device 530 does not have the updated configuration data. In addition, the third entry device 530 may further seek additional information from the second entry device 520, including the updated configuration data or information.

Aside from sending a request to the third entry device 530, the second entry device 520 may send out another request 524 to yet another entry device operating within the network 500. And particularly in this illustrative arrangement, the second network device 520 issues another request 524 to a fourth entry device 540 (i.e., Lock 4) operating within the network 500. Again, this second request 524 identifies the initial requester of this request 524 as the second entry device 520 and requests or asks the fourth entry device 540 if this fourth entry device has the updated configuration data or configuration information.

In response to this request 524 from the second entry device 520, the fourth entry device 540 transmits a reply 544 back to the second entry device 520 (i.e., Lock 5). Specifically, the fourth entry device 540 transmits a reply 544 that comprises an identifier identifying itself as the fourth entry device 540 operating within the network 500 and that, because it does not have a current or updated configuration data/information, that entry device 520 should transmit this updated configuration data back to the fourth entry device 540.

In addition, the third entry device, may transmit a request 542 to a fifth entry device 550 (i.e., Lock 5). Specifically, the third entry device 530 transmits an identifier identifying itself as the third entry device operating within the network and that it was inquiring as to whether this fifth entry device 550 had the updated configuration data.

In response to this request 542 from the third entry device 530, the fifth entry device 550 transmits a reply 552 to the fourth entry device (Lock 4). Specifically, the fifth entry device 550 transmits an identifier identifying itself as the fifth entry device 550 operating within the network and that it is seeking the updated configuration data for operating within the network 500.

The description of the different advantageous embodiments has been presented for purposes of illustration and description, and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

I claim:

1. A perimeter access system comprising:
a plurality of entry devices;
at least one gateway;
at least one radio link enabling the plurality of entry devices to be in radio communication with the at least one gateway; and
at least one network server operatively coupled to the at least one gateway by way of an IP connection,
wherein the one or more gateways act as a transparent bridge.

2. The invention of claim 1 wherein the perimeter access system comprises a Low Power Wide Area Network (LPWAN) perimeter access system.

3. The invention of claim 2 wherein the LPWAN perimeter access system utilizes an LPWAN standard protocol.

4. The invention of claim 1 wherein the perimeter access system grants access to a secured perimeter.

5. The invention of claim 4 wherein the secured perimeter comprises an enclosed outdoor space.

6. The invention of claim 5 wherein the enclosed outdoor space comprises a hotel room.

7. The invention of claim 1 wherein the entry device is provided on a moveable barrier.

8. The invention of claim 7 wherein the moveable barrier comprises a hotel room door.

9. The invention of claim 1 wherein the gateway converts converting Radio Frequency (RF) packets to IP packets.

10. The invention of claim 1 wherein the perimeter access system is configured as a LoRaWAN network architecture deployed in a star-of-stars topology.

11. The invention of claim 1 wherein the network server comprises a cloud-based platform solution.

12. The invention of claim 1 wherein the perimeter access system comprises a mesh perimeter access system.

13. The invention of claim 1 wherein the perimeter access system comprises a Low Power Wide Area Network (LPWAN) perimeter access system.

13. A method of providing remote access to an entry device, comprising:
accessing a perimeter access system by an authorized user;
requesting an entry device configuration by the authorized user;
validating the request;
authorizing the request; and
applying the requested entry device configuration to the entry device.

14. The invention of claim 13 wherein the entry device comprises a mesh node.

15. The invention of claim 13 wherein the authorized user comprises a hotel administrator.

16. The invention of claim 13 wherein the entry device comprises a moveable barrier.

17. The invention of claim 16 wherein the moveable barrier comprises a hotel room door.

18. The invention of claim 13 further comprising the step of accessing the perimeter access system utilizing a mobile computing device.

19. The invention of claim 18 wherein the mobile computing device comprises a smartphone.

20. The invention of claim 13 further comprising the step of validating the request by determining a status of an area related to the barrier to entry.

21. The invention of claim 13 further comprising the step of sending a message to an authorized user indicating a status of the request.

22. The invention of claim 13 further comprising the step of monitoring a status of the entry device.

23. The invention of claim 13 further comprising the step of reconfiguring the entry device.
